(19) United States
(12) Patent Application Publication
(10) Pub. No.: US 2020/0126551 A1
(43) Pub. Date: Apr. 23, 2020

(54) METHOD, DEVICE, AND COMPUTER PROGRAM PRODUCT FOR PROCESSING VOICE INSTRUCTION

(71) Applicant: Samsung Electronics Co., Ltd., Suwon-si (KR)

(72) Inventors: Kai XIONG, Nanjing (CN); Jianguo YUAN, Nanjing (CN); Hua FANG, Nanjing (CN); Ming LIU, Nanjing (CN)

(21) Appl. No.: 16/661,450

(22) Filed: Oct. 23, 2019

(30) Foreign Application Priority Data
Oct. 23, 2018 (CN) 201811234283.0

(51) Int. Cl. G10L 15/22; G06N 20/00; G10L 17/00; G10L 15/06; G10L 15/18

(52) U.S. Cl. CPC G10L 15/22; G06N 20/00; G10L 17/005; G10L 2015/0631; G10L 15/18; G10L 2015/223; G10L 2015/226; G10L 15/063

(57) ABSTRACT

A method for processing a voice instruction received at a plurality of devices is provided. The method includes creating a group list including the plurality of devices, receiving information regarding the voice instruction from each device in the group list based on the plurality of devices receiving the voice instruction from a user, selecting at least one device in the group list by processing the received information, and causing the selected at least one device to perform an operation corresponding to the voice instruction.

### CROSS-REFERENCE TO RELATED APPLICATION(S)

This application is based on and claims priority under 35 U.S.C. § 119(a) of a Chinese patent application number 201811234283.0, filed on Oct. 23, 2018, in the Chinese Patent Office, the disclosure of which is incorporated by reference herein in its entirety.

### BACKGROUND

### 1. Field

The disclosure relates to voice recognition. More particularly, the disclosure relates to technologies for processing a voice instruction received at multiple intelligent devices.

### 2. Description of Related Art

With the development of voice recognition and natural language processing technology, an intelligent device is conveniently used by users for the voice recognition or voice control.

Machine learning technology is used to train a model for learning user behaviors by collecting a large amount of user data, so as to output a result corresponding to input data.

When a voice instruction is received at a plurality of intelligent devices, the intelligent devices process the voice instruction individually. In this case, the intelligent devices may redundantly process the voice instruction, which may not only cause unnecessary operations or mis-operations, but also output a response to the voice instruction and interrupt an intelligent device that actually needs to or is able to process the voice instruction, so a user may not be provided with a good result from the intelligent device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method, a device, and a computer program product for processing a voice instruction received at intelligent devices, in order to improve the accuracy and efficiency of operations at the devices and improve the user experience.

Additional aspects will be set forth in part in the description which follows and, in part, will be apparent from the description, or may be learned by practice of the presented embodiments.

In accordance with an aspect of the disclosure, a method for processing a voice instruction received at a plurality of devices is provided. The method includes creating a group list including the plurality of devices, receiving information regarding the voice instruction from each device in the group list based on the plurality of devices receiving the voice instruction from a user, selecting at least one device in the group list by processing the received information, and causing the selected at least one device to perform an operation corresponding to the voice instruction.

In an embodiment of the disclosure, the method further includes adding, to the group list, a device which is registered to an account of the user.

In an embodiment of the disclosure, the at least one device is selected by processing the received information and additional information related to at least one of current context, time, position, or user information.

In an embodiment of the disclosure, the method further includes identifying a user identity based on a voice print of the voice instruction, wherein the at least one device is selected based on the identified user identity.

In an embodiment of the disclosure, the method further includes training a machine learning model based on information received from the plurality of devices, wherein the trained machine learning model is used for determining a device to be selected in the group list.

In an embodiment of the disclosure, the method further includes training a machine learning model based on a user feedback to the selected at least one device, wherein the trained machine learning model is used for determining a device to be selected in the group list.

In an embodiment of the disclosure, the at least one device is selected according to a priority between the plurality of devices about the operation corresponding to the voice instruction.

In an embodiment of the disclosure, the at least one device is selected according to a functional word included in the voice instruction, the selected at least one device having a function corresponding to the word.

In an embodiment of the disclosure, the selecting of the at least one device in the group list includes selecting at least two devices in the group list based on the voice instruction having at least two functional words which correspond to different functions respectively, wherein the causing of the selected at least one device to perform the operation includes causing the selected at least two devices to respectively perform at least two operations which correspond to the different functions respectively.

In an embodiment of the disclosure, the causing of the selected at least one device to perform the operation includes causing the selected at least one device to display a user interface for selecting a device in the group list, wherein the selected device is caused to perform the operation corresponding to the voice instruction instead of the selected at least one device.

In an embodiment of the disclosure, the operation performed by the selected at least one device includes displaying an interface, and the displayed interface is different based on the selected at least one device.

In an embodiment of the disclosure, the selected at least one device communicates with other devices of the plurality of devices to avoid the same operation to be performed at the selected at least one device.

In an embodiment of the disclosure, the selecting the at least one device includes prioritizing the at least one device based on the received information.

In accordance with another aspect of the disclosure, an electronic device for processing a voice instruction received at a plurality of devices is provided. The electronic device includes a memory storing instructions, and at least one processor configured to execute the instructions to create a group list including the plurality of devices, receive information regarding the voice instruction from each device in the group list based on the plurality of devices receiving the voice instruction from a user, select at least one device in the group list by processing the received information, and cause the selected at least one device to perform an operation corresponding to the voice instruction.

In accordance with another aspect of the disclosure, a device for processing a voice instruction received at a plurality of devices including the device is provided. The device includes a memory storing instructions, and at least one processor configured to execute the instructions to receive the voice instruction from a user, transmit, to a manager managing a group list including the plurality of devices, information regarding the voice instruction such that the manager selects at least one device in the group list by processing the transmitted information, receive from the manager a request causing the device to perform an operation corresponding to the voice instruction when the device is included in the selected at least one device, and perform the operation corresponding to the voice instruction.

In an embodiment of the disclosure, the manager is a server.

In an embodiment of the disclosure, the device is the manager, and the at least one processor is further configured to execute the instructions to transmit to another device a request causing the other device to perform the operation corresponding to the voice instruction when the other device is included in the selected at least one device.

In an embodiment of the disclosure, the at least one processor is further configured to execute the instructions to display a user interface including the plurality of devices in the group list, and based on receiving a user input selecting one or more devices in the group list, cause the selected one or more devices to perform the operation corresponding to the voice instruction instead of the device.

In an embodiment of the disclosure, the plurality of devices in the group list are registered to an account of the user.

In an embodiment of the disclosure, the group list includes a device registered to an account of another user.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a structure of a group management module according to an embodiment of the disclosure;

FIG. 2 is a schematic flowchart of creating a group list according to an embodiment of the disclosure;

FIG. 3 is a schematic diagram of a created group list and devices therein according to an embodiment of the disclosure;

FIG. 4 is a schematic diagram illustrating content of data according to an embodiment of the disclosure;

FIG. 5 is a schematic diagram illustrating a method of selecting a device using a machine learning module according to an embodiment of the disclosure;

FIG. 6 is a flowchart of a method of training a machine learning module according to an embodiment of the disclosure;

FIG. 7 is a schematic diagram for explaining an example scenario 1 according to an embodiment of the disclosure;

FIG. 8 is a schematic diagram for explaining an example scenario 2 according to an embodiment of the disclosure;

FIG. 9 is a schematic diagram for explaining an example scenario 3 according to an embodiment of the disclosure;

FIG. 10 is a schematic diagram for explaining an example scenario 4 according to an embodiment of the disclosure;

FIG. 11 is a schematic diagram for explaining an example scenario 5 according to an embodiment of the disclosure;

FIG. 12 is a schematic diagram for explaining an example scenario 6 according to an embodiment of the disclosure;

FIG. 13 is a schematic diagram for explaining an example scenario 7 according to an embodiment of the disclosure;

FIG. 14 is a schematic diagram for explaining an example scenario 8 according to an embodiment of the disclosure;

FIG. 15 is a schematic diagram for explaining an example scenario 9 according to an embodiment of the disclosure;

FIG. 16 is a schematic diagram for explaining an example scenario 10 according to an embodiment of the disclosure; and

FIG. 17 is a flowchart of a method for processing a voice instruction received at devices according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the singular forms “a”, “an” and “the” are intended to include the plural forms as well, unless the context clearly indicates otherwise. It should be understood that the terms “comprising,” “including,” and “having” are inclusive and therefore specify the presence of stated features, numbers, operations, components, units, or their combination, but do not preclude the presence or addition of one or more other features, numbers, operations, components, units, or their combination. In particular, numerals are to be understood as examples for the sake of clarity, and are not to be construed as limiting the embodiments by the numbers set forth.

In an embodiment of the disclosure, the terms, such as “ . . . unit” or “. . . module” should be understood as a unit in which at least one function or operation is processed and may be embodied as hardware, software, or a combination of hardware and software.

It should be understood that, although the terms “first,” “second,” etc. may be used herein to describe various elements, and these elements should not be limited by these terms. These terms are used to distinguish one element from another. For example, a first element may be termed a second element within the technical scope of an embodiment of the disclosure.

Expressions, such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Embodiments of the disclosure disclose a method and device for processing a voice instruction received at multiple intelligent devices. In the disclosure, the voice instruction may be a voice command. The voice instruction may include a first voice command to activate the intelligent devices, and a second voice command about an action. The devices activated by the first voice command may process the voice instruction and perform the action based on the second voice command. When a user says a voice instruction around a plurality of devices, the devices may react to the voice instruction and some of the devices may not perform an operation corresponding to the voice instruction.

In an embodiment, when a voice instruction is received at a plurality of devices, at least one device may be selected and may perform an operation corresponding to the voice instruction. For example, when a user says “play music” at home, at least one device may be selected and play music.

In an embodiment, a device for processing a voice instruction may include a management module. The management module may be referred to as a manager, and implemented as a software module, but is not limited thereto. The management module may be implemented as a hardware module, or a combination of a software module and a hardware module. The management module may be a digital assistant module. The device may further include more modules.

In the disclosure, modules of the device are named to distinctively explain their operations which are performed by the modules in the device. Thus, it should be understood that such operations are performed according to an embodiment and should not be interpreted as limiting a role or a function of the modules. For example, an operation which is described herein as being performed by a certain module may be performed by another module or other modules, and an operation which is described herein as being performed by interaction between modules or their interactive processing may be performed by one module. Furthermore, an operation which is described herein as being performed by a certain device may be performed at or with another device to achieve the same effect of an embodiment.

The device may include a memory and a processor. Software modules of the device, such as program modules, may include a series of instructions stored in the memory. When the instructions are executed by the processor, corresponding operations or functions may be performed at the device.

The module may include sub-modules. The module and sub-modules may be in a hierarchy relationship, or they may be not in the hierarchy relationship because the module and sub-modules are merely named to distinctively explain their operations which are performed by the module and sub-modules in the device.

According to an embodiment, the manager may include a group management module, a data communication module, and an inference module. The manager may further include a correction module. The manager may be a server or located at the server, but is not limited thereto. The manager may be or located at a device receiving a voice instruction directly from a user. The manager may be implemented as a part of a digital assistant.

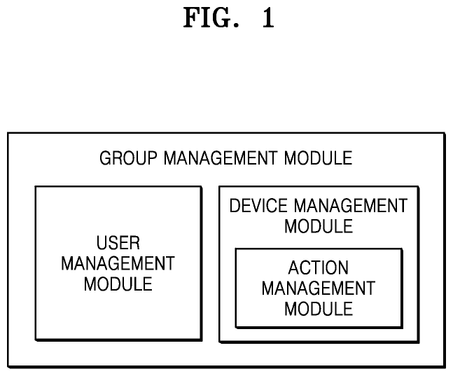

An embodiment including the group management module of the manager will be explained by referring to FIG. 1.

FIG. 1 is a schematic diagram illustrating a structure of a group management module according to an embodiment of the disclosure.

Referring to FIG. 1, the group management module may include a user management module, a device management module, and an action management module.

A user's account registered to the manager or a user's profile may be managed by the user management module. Devices of the user may be managed by the device management module. Actions supported by the devices may be managed by the action management module.

In an embodiment, devices, such as intelligent devices or smart devices may be registered to an account of a user. The devices may be grouped together according to a user profile. The device may be controlled under the account of the user or the user profile. For the sake of brevity, it is illustrated in the disclosure that a group of the devices of the user is managed by the group management module, but a plurality of groups of devices of users may be managed by the group management module.

Each device may be uniquely identified by a unique identifier, such as a media access control (MAC) address, but not limited to MAC. The device may be identified by its user's account if the device is registered to the account of the user.

In an embodiment, the manager may provide a user with a list of his or her registered devices which are turned on or connected to a network. The list may be a group list of the devices. In an embodiment, the network may be the Internet, but is not limited thereto. For example, the network may be the user's home network.

In an embodiment, based on a user request, a group list including the user's devices may be created and configured. That is, the user may create the group list including the devices registered to the user's account and add a new device to the group list, remove a device from the group list, or move a device to another group list.

In an embodiment, actions supported by a device may be managed by the action management module. In an embodiment, actions supported by all devices of the group list may be managed at a group level. Here, an action supported by a device may consist of at least one operation performable at the device. For example, an action of playing music may include an operation of searching for a specific music, an operation of accessing a file of the music, and an operation of playing the file. In the disclosure, an action may be interchangeable with an operation.

The user management module may manage a user of devices in a group list. The user may be identified by a logged-in account of the user. In an embodiment, another user may be added to the group list by the user's invitation. In an embodiment, the user may be a user profile created based on usage of the devices in the group list. For example, where a certain user frequently controls devices at home by voice without registration, a user profile may be created according to the user's voice print.

In an embodiment, the device management module may manage devices by groups. Devices in a group list may be associated with an account of a user. The devices in the group list may be devices connected to a network, and the group list may be an online device list including the devices connected to the network, but is not limited thereto. The group list and the online device list may not be the same. When a new device joins in the network, list information is updated, and the new device may be added to the online device list. When a device is disconnected from the network, the device may be removed from the online device list. In an embodiment, the network may be the Internet, but is not limited thereto. For example, the network may be the user's home network.

In an embodiment, the action management module may manage a list of actions supported by all devices in a group list, and priorities of the actions.

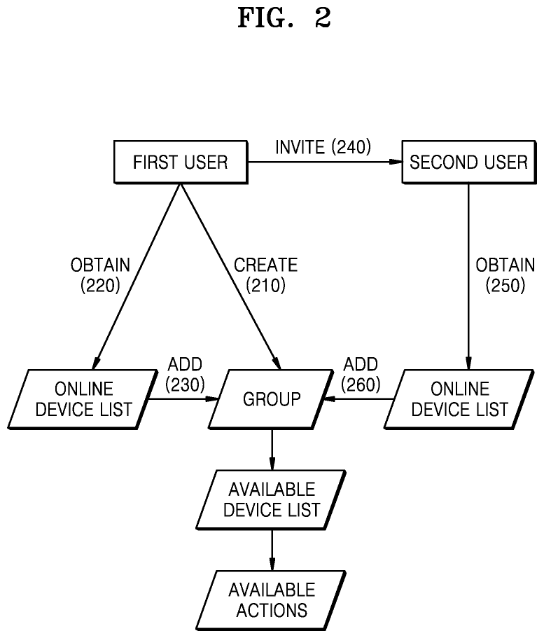

According to an embodiment, a group list may include devices of a first user, and devices of a second user, which will be explained by referred to FIG. 2.

FIG. 2 is a schematic flowchart of creating a group list according to an embodiment of the disclosure.

Referring to FIG. 2, a group list including devices of the first user may be created at the manager at operation 210. In an embodiment, an available device list including available devices and a list of actions supported by the available devices may be obtained, after the group list including the devices is created. Here, the available devices may be devices that are ready to listen to a voice instruction of a user, and connected to a network. The network may be the Internet, but is not limited thereto. For example, the network may be the first user's home network.

At operation 220, the first user's online device list including devices connected to the network may be obtained at the manager. The first user's online device list may be obtained through the first user's device at the manager. In an embodiment, the group list may be created based on the online device list, that is, the created group list may include the same devices with the online device list.

At operation 230, a device selected from the first user's online device list by the first user may be added to the group list at the manager. The device may be selected through a user interface provided to one of the user's device. As the selected device is added to the group list, the available device list and the list of actions supported by the available devices may be updated accordingly.

At operation 240, an invitation may be sent from the first user to the second user. The invitation may be sent to the second user when the second user's device is connected to the first user's home network. The invitation may be sent via the manager.

At operation 250, the second user's online device list including devices connected to a network may be obtained at the manager. The second user's online device list may be obtained through the second user's device. Here, the network may be the Internet, but is not limited thereto. For example, the network may be the first user's home network. In an embodiment, the second user's online device list may be obtained when the second user accepts the invitation of the first user.

At operation 260, a device selected in the second user's online device list may be added to the group at the manager. As the selected device is added to the group list, the available device list and the list of actions supported by the available devices may be updated accordingly.

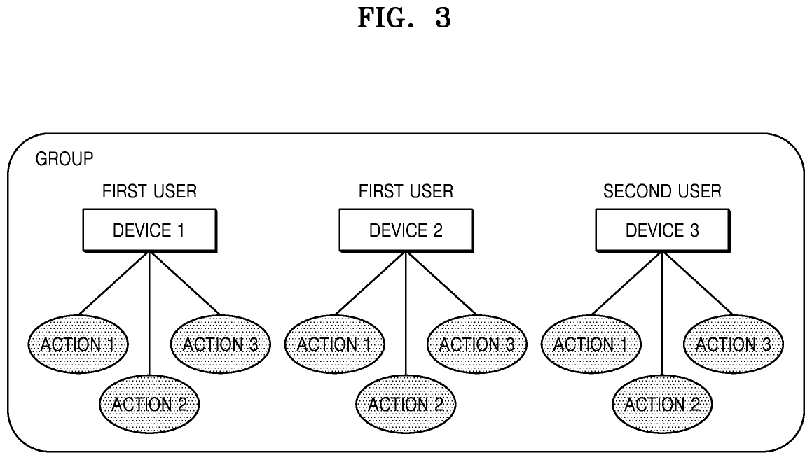

According to an embodiment, the group list to which the second user's device is added will be explained by referring to FIG. 3.

FIG. 3 is a schematic diagram of a created group list and devices therein according to an embodiment of the disclosure.

Referring to FIG. 3, a group list may include Device 1 and Device 2 of the first user, and Device 3 of the second user, when the second user's device is added to the group list.

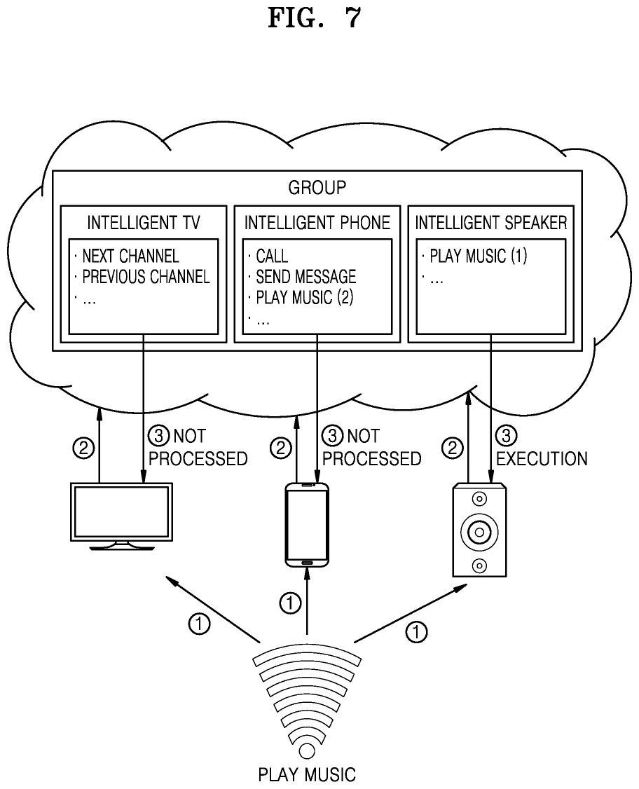

In an embodiment, the group list may include information about actions supported by devices in the group list. For example, as illustrated in FIG. 3, Device 1, Device 2, and Device 3 may be able to perform Action 1, Action 2, and Action 3. Actions supported by the devices may be different from each other. An embodiment where some actions supported by the devices are the same will be explained later by referring to FIG. 7.

According to an embodiment, the manager may include the data communication module for communicating with other devices.

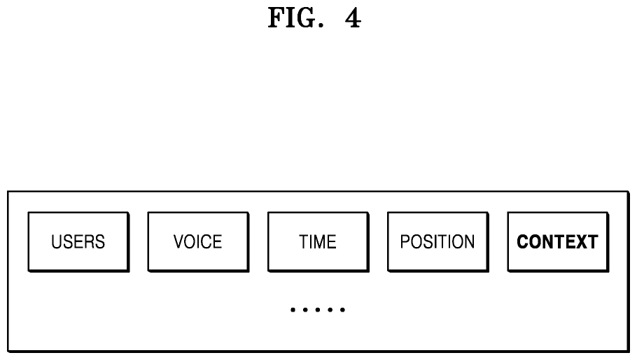

In an embodiment, the data communication module may receive information regarding a voice instruction received at devices. The information regarding the voice instruction or data regarding the voice instruction will be explained by referring to FIG. 4.

FIG. 4 is a schematic diagram illustrating content of data according to an embodiment of the disclosure.

The devices may be in the group list, and the information regarding the voice instruction may be received at the manager in response to the devices receiving the voice instruction.

Referring to FIG. 4, a device that receives the voice instruction having an audio strength greater than a threshold may transmit data regarding the voice instruction to the manager. The audio strength may be determined by a pitch of the voice instruction. Here, the data may be audio data recorded at the device, but is not limited thereto. For example, the data may include text which is converted from the voice instruction by automatic speech recognition (ASR) of the device.

In an embodiment, the data may include data regarding audio strength. The audio strength may be determined by a pitch of the voice instruction recorded at the device, and used to determine a distance between a user and a device receiving the user's voice instruction. In an embodiment, at least one device may be selected based on an audio strength of a voice instruction received at each device. For example, a device that receives a voice instruction of the greatest audio strength among devices in the group list may be selected.

In an embodiment, the data may include data regarding at least one of content of the voice instruction, a position of the device or the user, time, user information, or current context or a situation of the device, as shown in FIG. 4, but is not limited thereto.

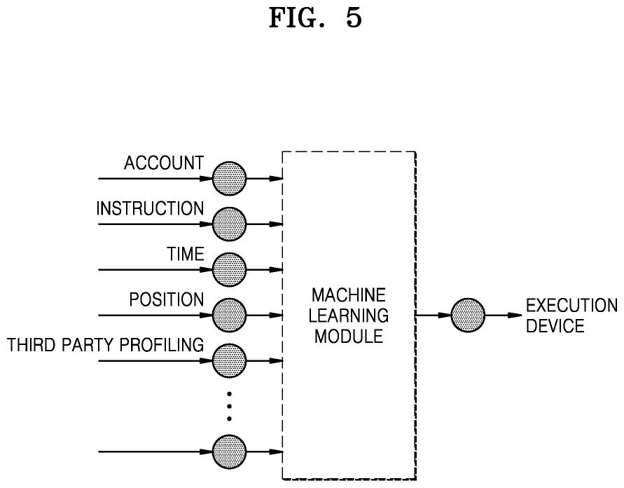

According to an embodiment, the manager may include the inference module for selecting at least one device in the group list. The inference module will be explained by referring to FIG. 5.

FIG. 5 is a schematic diagram illustrating a method of selecting a device using a machine learning module according to an embodiment of the disclosure.

Referring to FIG. 5, the manager may receive the information regarding the voice instruction from each device, and the inference module of the manager may select a device in the group list. The device may be selected from available devices. In an embodiment, the device may be selected based on content of the voice instruction. For example, a device that is capable of performing an operation corresponding to the voice instruction may be selected. In an embodiment, the device may be selected based on current context or a situation of the device or the available devices.

In an embodiment, a machine learning module may be used to select one or more devices from the group list based on the information received by the data communication module. For example, the one or more devices may be selected based on factors including, but not limited to, a user, a behavior pattern of the user, time, a position of the available devices or the user, a command type, a device priority, an action priority, etc. The machine learning module may be trained based on the above factors. In the disclosure, the machine learning module may be interchanged with a machine learning model.

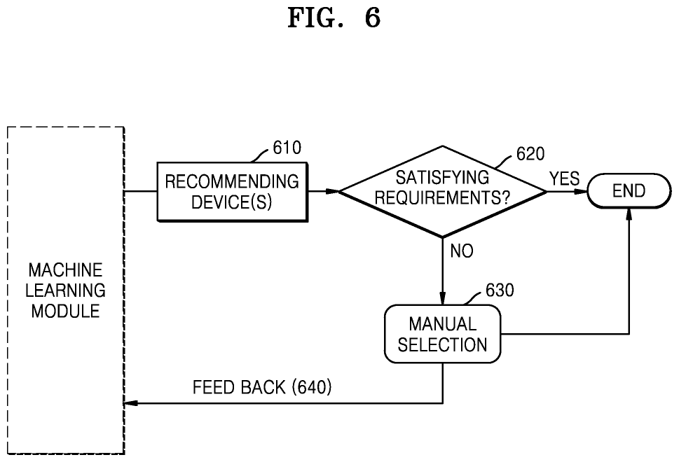

According to an embodiment, the manager may further include a correction module to train the machine learning model, which will be explained by referring to FIG. 6.

FIG. 6 is a flowchart of a method of training a machine learning module according to an embodiment of the disclosure.

Referring to FIG. 6, the manager may select at least one device using the machine learning module at operation 610.

At operation 620, the manager may wait for a user's confirmation about the selected device. In an embodiment, whether the selected device performs an operation corresponding to the voice instruction or not may be confirmed before causing the selected device to perform the operation corresponding to the voice instruction. If it is confirmed by the user's obvious expression or lapse of time, then the selected device is caused to perform the operation corresponding to the voice instruction.

At operation 630, when the user is not satisfied with the selection of the device and denies the selection of the device by the manager, the manager may provide the user with the group list or the list of the available devices for letting the user manually select a device from among them. Here, the group list or the list of the available devices may be displayed on one of the user's devices. The device selected by the user may perform an operation corresponding to the voice instruction.

At operation 640, information about the user's manual selection may be provided to the manager for training the machine learning module.

In an embodiment, a user's comment may be received at the manager after the selected device performs the operation corresponding to the voice instruction, and the user's comment may be used to train the machine learning module. The user's feedback, such as the above confirmation or comment may be used to train the machine learning module.

Various scenarios will be explained according to an embodiment by referring to FIGS. 7-16.

FIG. 7 is a schematic diagram for explaining an example scenario 1 according to an embodiment of the disclosure.

Referring to FIG. 7, when there are multiple devices supporting voice control at a user's home and the user says a voice instruction around the multiple devices, the most suitable device for performing an operation corresponding to the voice instruction may be selected according to an embodiment. According to an embodiment, the user may not need to search for a suitable device or specify the suitable device in the voice instruction. According to an embodiment, interference caused by a device unnecessarily performing an operation may be reduced because a device that is suitable for the voice instruction is selected to perform an operation corresponding to the voice instruction, and a device that is not suitable for the voice instruction does not respond to the voice instruction.

For example, where a user's group list of devices includes an intelligent television (TV), an intelligent phone, and an intelligent speaker, when a voice instruction of the user saying “play music” is received at the devices, each device may send information regarding the received voice instruction to the manager. The information regarding the received voice instruction may be audio data recorded at each device, but is not limited thereto. For example, the data may include text which is converted from the voice instruction by ASR of each device.

The manager may receive the information regarding the voice instruction from each device within a certain period of time with consideration for lagging. The manager may determine whether the group list includes an action, supported by the devices of the group list, corresponding to the voice instruction. That is, the manager may determine whether devices of the group list are capable of performing the action corresponding to the voice instruction. When the group list does not include the action for the voice instruction, a response indicating that there is no device capable of playing music is returned to the user. Referring to FIG. 7, when the group list includes the action for the voice instruction, all devices capable of playing music, such as the intelligent phone and the intelligent speaker may be selected. Further, referring to Table. 1, priorities between the devices for the action may be determined, and a device with the highest priority for the action, the intelligent speaker, may be selected to play music. In an embodiment, a response for causing an unselected device not to output sound may be returned to the unselected device.

TABLE 1
Play Music

| Devices | Priority | Execution |
|---|---|---|
| Intelligent | 1 | ◯ |
| Speaker | | |
| Intelligent Phone | 2 | X |

In an embodiment, a machine learning model may be used to select a suitable device and content. For example, referring to Table 2, when a voice instruction of a user saying “Play Music” is received at devices at home late at night, and the machine model has been trained by or considers a result that in early morning or late at night the user prefers to use the intelligent phone to play music rather than the intelligent speaker, the intelligent phone may be selected to play music.

TABLE 2
Play Music

| Devices | Priority | Time | Execution |
|---|---|---|---|
| Intelligent | 1 | Late at | X |
| Speaker | | Night | |
| Intelligent | 2 | | ◯ |
| Phone | | | |

Referring to Table 3, different music content may be played according to a user saying the voice instruction. If a father says the voice instruction at home late at night, his intelligent phone may be selected to play classical music. If his son says the voice instruction at home late at night, the father's intelligent phone may be selected to play children's music. Identity of a user may be determined by a voice print of the voice instruction.

TABLE 3
Play Music

| Devices | Priority | Time | User | Execution | Content |
|---|---|---|---|---|---|
| Intelligent | 1 | Late at | | X | |
| Speaker | | Night | | | |
| Intelligent | 2 | | Children | ◯ | Children's |
| Phone | | | | | music |
| | | | The | | Classical |
| | | | elderly | | music |

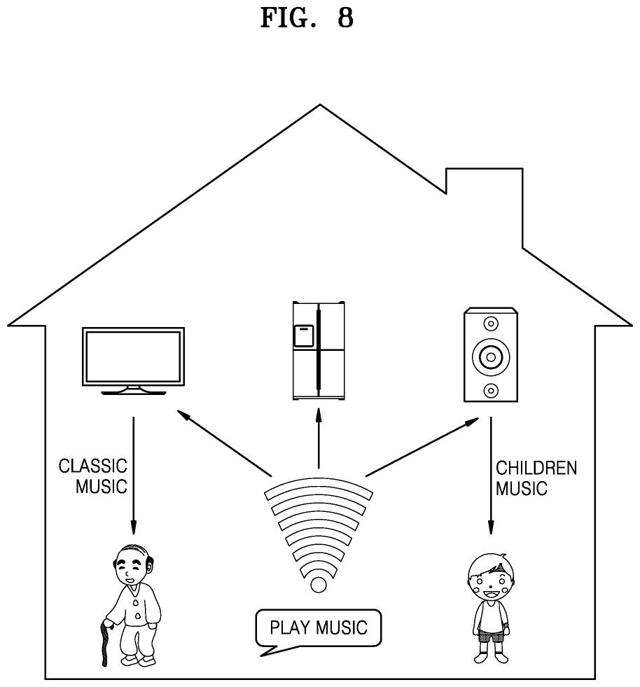

FIG. 8 is a schematic diagram for explaining an example scenario 2 according to an embodiment of the disclosure.

Referring to FIG. 8, if the voice instruction is received during the daytime, and the machine learning model has been trained by or considers a result that the father prefers to listen to music by the television and his son prefers to listen to the speaker, the television or the speaker is selected according to the user saying the voice instruction to play classical music or children's music.

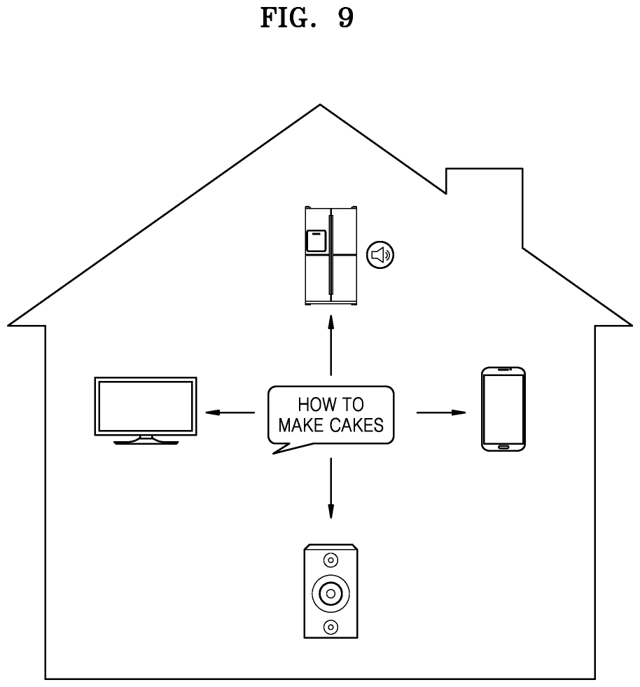

FIG. 9 is a schematic diagram for explaining an example scenario 3 according to an embodiment of the disclosure.

Referring to FIG. 9 and Table 4, the machine learning model may be trained by or consider functional words for selecting a device having a corresponding function. For example, when a voice instruction of a user saying “How to make cakes” is received at the devices, a refrigerator may be selected to show recipes of cakes, because the refrigerator has a function related to cooking, and the voice instruction also regards cooking. In an embodiment, when a television program is watched on the television, the television may be selected to display recipes of cakes. Devices that do not have a function corresponding to displaying recipes, such as a microwave oven, a smart speaker, and a washing machine, may not be selected. Devices that have a function corresponding to displaying recipes may have priorities based on the machine learning model. Devices that have the function corresponding to displaying recipes may have priorities based on an audio strength of a voice instruction.

TABLE 4

| Devices | Function |
|---|---|
| Television | TV |
| Smart Phone | Call |
| Smart Phone | Internet |
| | Access |
| Refrigerator | Cooking |
| Microwave Oven | Baking |
| Smart Speaker | Music |
| Washing | Clean |
| Machine | |
| . . . | . . . |

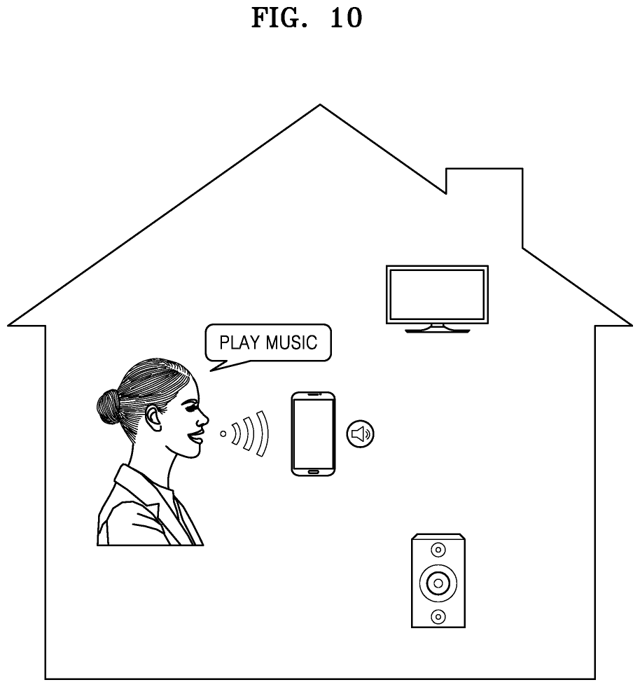

FIG. 10 is a schematic diagram for explaining an example scenario 4 according to an embodiment of the disclosure.

Referring to FIG. 10, when a voice instruction of a user saying “Play Music” is received at a smartphone, a smart TV, and a smart speaker, and all of these devices support an action of playing music, a device at which a voice instruction having the strongest audio strength may be selected to play music.

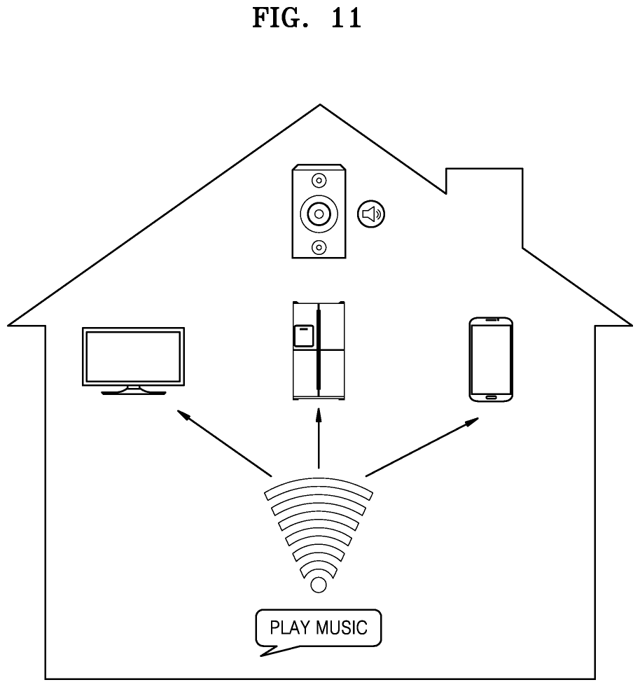

FIG. 11 is a schematic diagram for explaining an example scenario 5 according to an embodiment of the disclosure.

Referring to FIG. 11, a group list may include a plurality of devices, such as a TV, a refrigerator, a smartphone, and a speaker. A voice instruction such as “Play Music” may be received by the TV, the refrigerator, and the smartphone but not received at the speaker, which is more suitable for playing music than the other devices. In that case, the more suitable device (i.e., the speaker) may be selected to play music. In an embodiment, although a device does not detect the voice instruction, this device may be selected from the group list based on functions of devices in the group list. Whether the device missing the voice instruction is selected or not may be determined based on a distance between the device, and other devices or a user. In the example of FIG. 11, when the speaker is within a certain range from the other devices or the user, the speaker may be selected. Distances between the devices in the group list or distances between the devices and a user may be determined by learning audio strengths of voice instructions received at the devices. Distances between the devices in the group list or distances between the devices and a user may be determined as being relative.

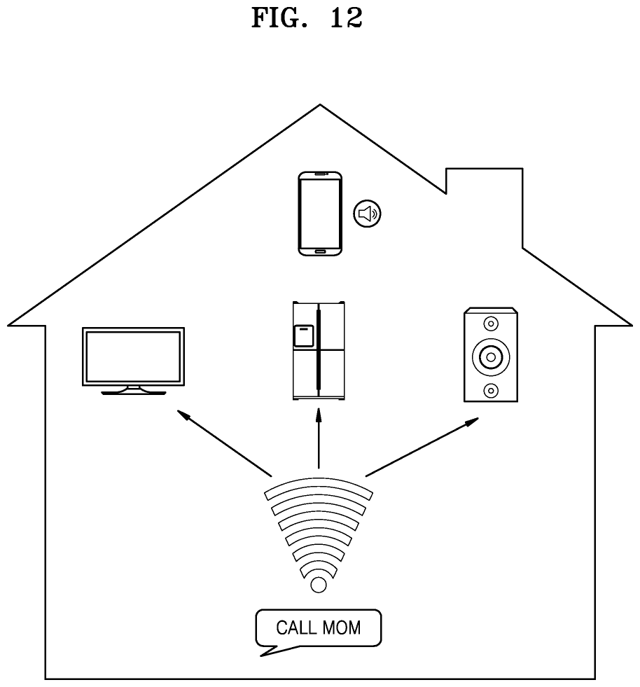

FIG. 12 is a schematic diagram for explaining an example scenario 6 according to an embodiment of the disclosure.

Referring to FIG. 12, when devices receiving a voice instruction do not have a function corresponding to the voice instruction, such as making a call, and there is a device in the group list that is capable of performing the function, such as a smartphone, the device that is capable of performing the function may be selected to respond to the voice instruction or perform the function corresponding to the voice instruction.

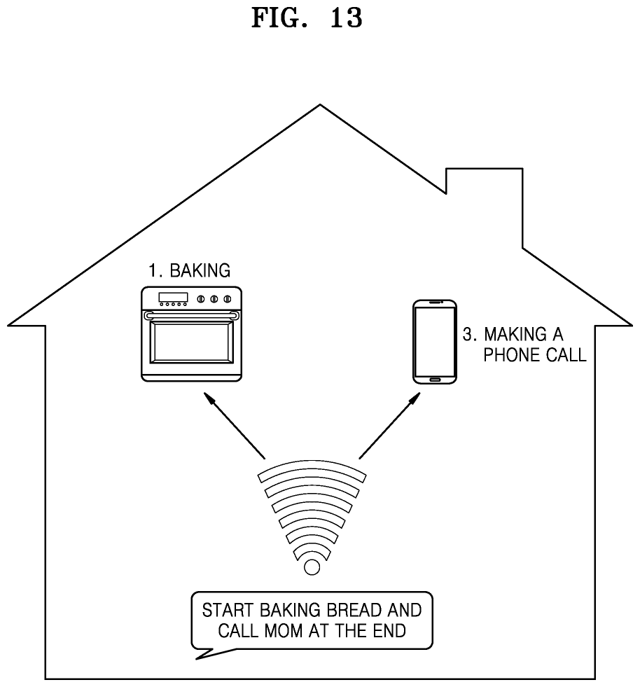

FIG. 13 is a schematic diagram for explaining an example scenario 7 according to an embodiment of the disclosure.

Referring to FIG. 13, a voice instruction may include at least two functional words. The functional words may respectively correspond to different functions. For example, when a voice instruction of a user saying “Start baking bread and call mom at the end” is received at devices of the group list, two devices respectively having functions of cooking and calling may be selected. In an embodiment, a selected device may perform an operation conditionally. In the example of FIG. 13, when the voice instruction includes a word regarding a condition, such as “at the end”, the selected device may be caused to perform an operation based on whether the condition is satisfied. The condition may be interpreted by the machine learning model. After bread is baked at an oven, a phone call to a user's mother is made at a smartphone. After an operation at the oven is performed, the oven may notify the manager and the manager may cause the smartphone to make the phone call.

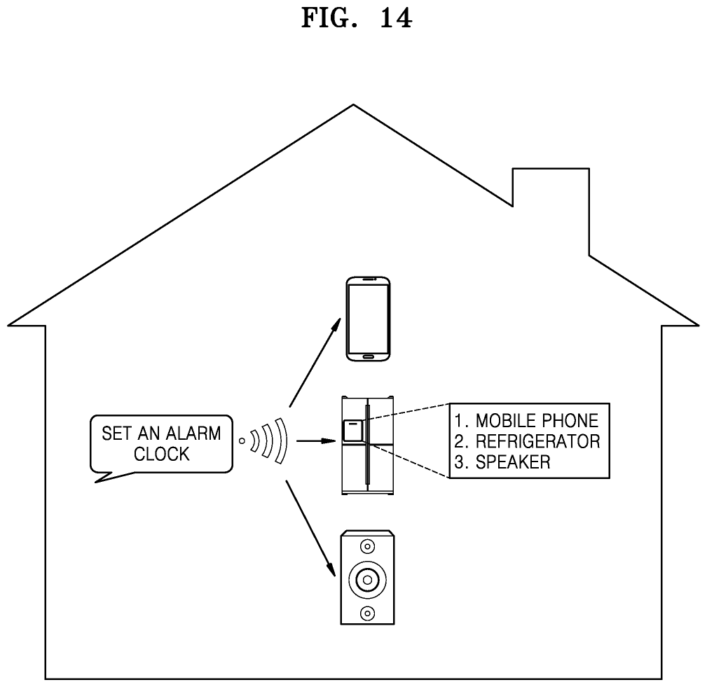

FIG. 14 is a schematic diagram for explaining an example scenario 8 according to an embodiment of the disclosure.

Referring to FIG. 14, a selection interface may be provided to the user's device when a plurality of suitable devices are available. For example, when a voice instruction of the user is “Set an alarm clock”, the selection interface may be displayed on the user's device to enable the user to select one or more from the available devices. The device displaying the selection interface may be determined based on distances between the user and devices suitable for displaying the selection interface. The device displaying the selection interface may be a device that is the closest to the user among devices having a display.

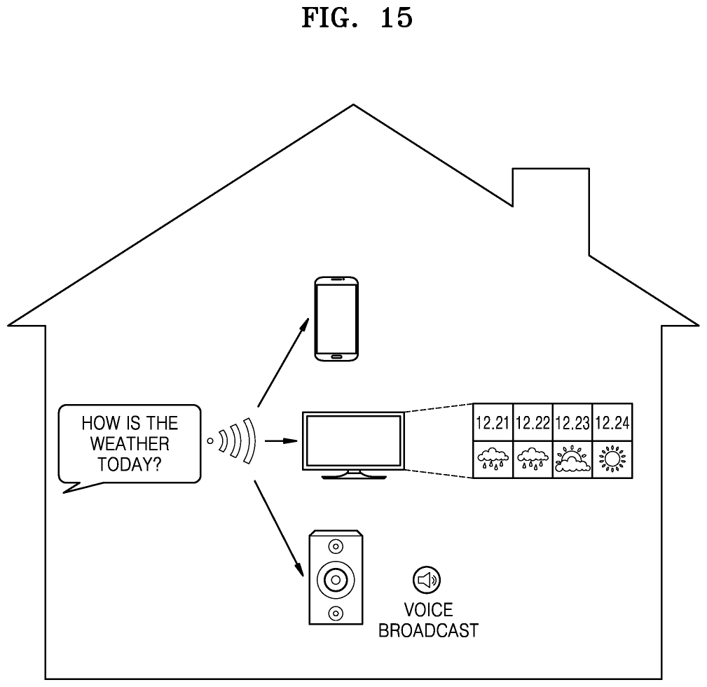

FIG. 15 is a schematic diagram for explaining an example scenario 9 according to an embodiment of the disclosure.

Referring to FIG. 15, different devices may be selected to perform different operations corresponding to a voice instruction. For example, when a voice instruction of a user asking “How is the weather today” is received at devices, a device suitable for displaying content and a device for outputting sound may be selected to display the content and outputting the sound. For example, when the voice instruction asks about the weather, a weather interface is displayed on the TV that has the top priority for displaying content, and a weather broadcast is played by the speaker that has the top priority for outputting the sound.

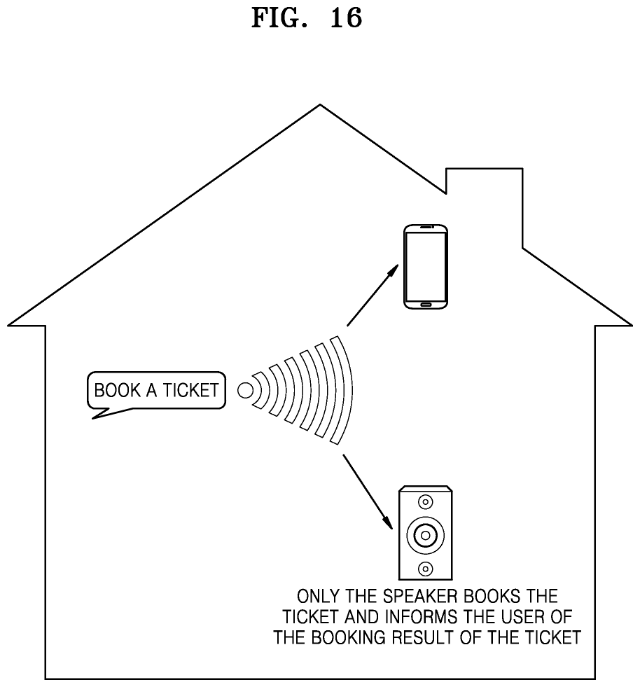

FIG. 16 is a schematic diagram for explaining an example scenario 10 according to an embodiment of the disclosure.

Referring to FIG. 16, a voice instruction may be interpreted as a one-time instruction, and only one device may be selected to perform an operation corresponding to the one-time instruction. For example, a voice instruction regarding a purchase may be the one-time instruction. Here, communication between devices may be used to guarantee that the operation is performed once. For example, when asked to book a flight ticket, only one reservation may be made, and double-spending is avoided.

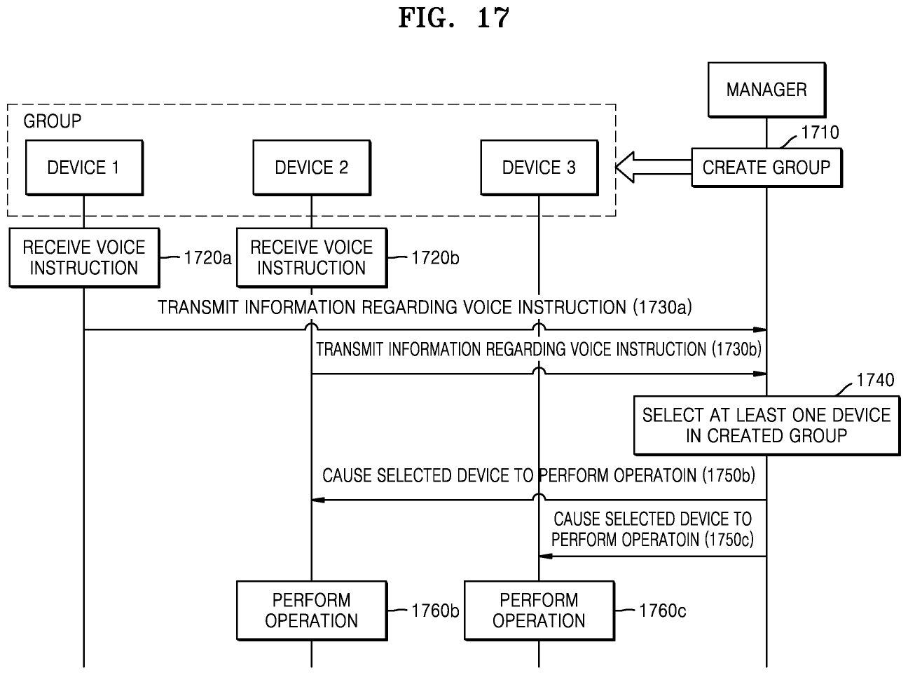

FIG. 17 is a flowchart of a method for processing a voice instruction received at devices according to an embodiment of the disclosure.

Referring to FIG. 17, a group list may be created at the manager at operation 1710. The group list may be created based on a user request, a user profile, or a user account to which devices are registered as explained above. The manager may be a server or running at the server, but is not limited thereto. The manager may be Device 1, Device 2, or Device 3 or running at Device 1, Device 2, or Device 3. The group list may include Device 1, Device 2, and Device 3. The group list may be updated in real time when a device is logged in or goes offline.

In an embodiment, a user may create a sub-account based on the group list to facilitate other users to use the manager for voice control, so as to meet customized needs of different users. Each account may be registered to the manager and identified by a voice print at the manager.

The account of the user which creates the group list may be a primary account that can modify and delete the group.

At operations 1720a and 1720b, a voice instruction may be received at Device 1 and Device 2. Here, Device 3 may not receive the voice instruction because Device 3 is too far from the user to hear the voice instruction or is blocked by a wall.

At operations 1730a and 1730b, information regarding the voice instruction may be transmitted from Device 1 and Device 2 to the manager. When the voice instruction is received at the devices, each device may determine an audio strength of the voice instruction. When the audio strength of the voice instruction is determined by a device as being lower than a set threshold, the voice instruction may be discarded at the device. When the audio strength of the voice instruction received at the device is higher than the set threshold, the device may send the information regarding the voice instruction, current context, time, position, and user, etc., to the manager.

At operation 1740, at least one device may be selected, by the manager, from the created group list based on the transmitted information regarding the voice instruction. For example, Device 2 and Device 3 may be selected. Device 3 that did not receive the voice instruction may be a candidate to be selected to perform an operation corresponding to the voice instruction as explained above. Here, different priorities may be defined for an action of each device.

When multiple devices support an action corresponding to the voice instruction at the same time, the at least one device suitable for performing the action may be selected according to the priority of the device.

The manager may recognize a user identity through the voice print. The group list may be determined according to position information in the data uploaded by the device. The voice instruction may be processed at a group level. A candidate device for the voice instruction may be selected according to actions supported by the device in the group list. A machine learning model may be trained and used to select the at least one device.

At operations 1750b and 1750c, the manager may cause the selected at least one device to perform an operation corresponding to the voice instruction. A request of performing the operation may be transmitted from the manager to Device 2 and Device 3.

At operations 1760b and 1760c, the selected at least one device may perform the operation corresponding to the voice instruction.

When selection of the at least one device does not satisfy the user, or a result of the operation performed by the selected device does not satisfy the user, user feedback may be returned to the manager to enhance the machine learning model.

It can be seen from the foregoing technical solutions that by the method and system for processing a voice instruction when multiple intelligent devices are online simultaneously provided by the disclosure, a voice instruction is processed at a level of the group on a server side, and a candidate device list capable of executing the voice instruction is filtered out, by analyzing actions of voice instructions of multiple devices in the group. One or more devices executing the voice instruction may be inferred intelligently by a machine learning model trained using a large amount of data, and an error correction function is provided. The results of error correction are fed back to the machine learning model, and the machine learning model is retrained to produce a system that better corresponds with each user's behavioral habits.

The disclosure operates one or more devices at the same time without turning off microphones of other devices, avoiding potential disorder caused by the voice instruction, improving convenience, and improving stability of voice operation. In addition, an execution device is recommended through the machine learning model, which provides users with a more convenient and accurate operating experience.

The disclosure discloses a method and system for processing a voice instruction when multiple intelligent devices are online simultaneously. By configuring the group information of the intelligent devices, the voice instruction may be flexibly processed when the multiple intelligent devices are online simultaneously, thereby improving accuracy and convenience of operations of the intelligent devices, and improving the user experience.

A memory is a computer-readable medium and may store data necessary for operation of the electronic device. For example, the memory may store instructions that, when executed by a processor of the electronic device, cause the processor to perform operations in accordance with the embodiments described above. Instructions may be included in a program.

A computer program product may include the memory or the computer-readable medium. The computer-readable medium may be a non-transitory computer-readable medium. The computer program product may be an electronic device including a processor and a memory.

The processor may be coupled to the memory to control the overall operation of the electronic device. For example, the processor may perform operations according to various embodiments. The processor may include a central processing unit (CPU), a graphics processing unit (GPU), an associative processing unit (APU), a Tensor processing unit (TPU), a vision processing unit (VPU), or a quantum processing unit (QPU), but is not limited thereto.

The computer readable storage media may be any data storage device which may store data read by a computer system. Examples of the computer readable storage media include a read only memory, a random access memory, a read only optical disk, a magnetic type, a floppy disk, an optical storage device, and a wave carrier (for example, data transmission via a wire or wireless transmission path through Internet).

In addition, it should be understood that various units or components of a device or a system in the disclosure may be implemented as a hardware component, a software component, or a combination thereof. According to defined processing performed by each of the units, those skilled in the art may implement each of the units for example by using a Field Programmable Gate Array (FPGA) or an Application Specific Integrated Circuit (ASIC).

In addition, various embodiments of the disclosure may be implemented as a computer code in a computer readable recording medium. Those skilled in the art may implement the computer code according to the descriptions of the above method. When the computer code is executed in a computer, the above embodiments of the disclosure may be implemented.

The various embodiments may be represented using functional block components and various operations. Such functional blocks may be realized by any number of hardware and/or software components configured to perform specified functions. For example, the various embodiments may employ various integrated circuit components, e.g., memory, processing elements, logic elements, look-up tables, and the like, which may carry out a variety of functions under control of at least one microprocessor or other control devices. As the elements of the various embodiments are implemented using software programming or software elements, the various embodiments may be implemented with any programming or scripting language, such as C, C++, Java, assembler, or the like, including various algorithms that are any combination of data structures, processes, routines or other programming elements. Functional aspects may be realized as an algorithm executed by at least one processor. Furthermore, the embodiment's concept may employ related techniques for electronics configuration, signal processing and/or data processing. The terms ‘mechanism’, ‘element’, ‘means’, ‘configuration’, etc. are used broadly and are not limited to mechanical or physical embodiments. These terms should be understood as including software routines in conjunction with processors, etc.

Various embodiments of the disclosure should be understood as various examples, and should not be interpreted as limitation of various embodiments. For the sake of brevity, related electronics, control systems, software development and other functional aspects of the systems may not be described in detail. Furthermore, the lines or connecting elements shown in the appended drawings are intended to represent functional relationships and/or physical or logical couplings between the various elements. It should be noted that many alternative or additional functional relationships, physical connections or logical connections may be present in a practical device. Moreover, no item or component is essential to the practice of the various embodiments unless it is specifically described as essential.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for processing a voice instruction received at a plurality of devices, the method comprising:
creating a group list comprising the plurality of devices;
receiving information regarding the voice instruction from each device in the group list based on the plurality of devices receiving the voice instruction from a user;
selecting at least one device in the group list by processing the received information; and
causing the selected at least one device to perform an operation corresponding to the voice instruction.

2. The method according to claim 1, further comprising:
adding, to the group list, a device which is registered to an account of the user.

3. The method according to claim 1, wherein the at least one device is selected by processing the received information and additional information related to at least one of current context, time, position, or user information.

4. The method according to claim 1, further comprising:
identifying a user identity based on a voice print of the voice instruction,
wherein the at least one device is selected based on the identified user identity.

5. The method according to claim 1, further comprising:
training a machine learning model based on information received from the plurality of devices,
wherein the trained machine learning model is used for determining a device to be selected in the group list.

6. The method according to claim 1, further comprising:
training a machine learning model based on a user feedback to the selected at least one device,
wherein the trained machine learning model is used for determining a device to be selected in the group list.

7. The method according to claim 1, wherein the at least one device is selected according to a priority between the plurality of devices about the operation corresponding to the voice instruction.

8. The method according to claim 1, wherein the at least one device is selected according to a functional word included in the voice instruction, the selected at least one device having a function corresponding to the word.

9. The method according to claim 1,
wherein the selecting of the at least one device in the group list comprises selecting at least two devices in the group list based on the voice instruction having at least two functional words which correspond to different functions respectively, and
wherein the causing of the selected at least one device to perform the operation comprises causing the selected at least two devices to respectively perform at least two operations which correspond to the different functions respectively.

10. The method according to claim 1,
wherein the causing of the selected at least one device to perform the operation comprises causing the selected at least one device to display a user interface for selecting a device in the group list, and
wherein the selected device is caused to perform the operation corresponding to the voice instruction instead of the selected at least one device.

11. The method according to claim 1, wherein the operation performed by the selected at least one device comprises displaying an interface, and the displayed interface is different based on the selected at least one device.

12. The method according to claim 1, wherein the selected at least one device communicates with other devices of the plurality of devices to avoid the same operation to be performed at the selected at least one device.

13. The method according to claim 1, wherein the selecting of the at least one device comprises:
prioritizing the at least one device based on the received information.

14. An electronic device for processing a voice instruction received at a plurality of devices, the electronic device comprising:
a memory storing instructions; and
at least one processor configured to execute the instructions to:
create a group list comprising the plurality of devices,
receive information regarding the voice instruction from each device in the group list based on the plurality of devices receiving the voice instruction from a user,
select at least one device in the group list by processing the received information, and
cause the selected at least one device to perform an operation corresponding to the voice instruction.

15. A device for processing a voice instruction received at a plurality of devices including the device, the device comprising:
a memory storing instructions; and
at least one processor configured to execute the instructions to:
receive the voice instruction from a user,
transmit, to a manager managing a group list including the plurality of devices, information regarding the voice instruction such that the manager selects at least one device in the group list by processing the transmitted information,
receive from the manager a request causing the device to perform an operation corresponding to the voice instruction when the device is included in the selected at least one device, and
perform the operation corresponding to the voice instruction.

16. The device according to claim 15, wherein the manager comprises a server.

17. The device according to claim 15,
wherein the device is the manager, and
wherein the at least one processor is further configured to execute the instructions to transmit to another device a request causing the other device to perform the operation corresponding to the voice instruction when the other device is included in the selected at least one device.

18. The device according to claim 15, wherein the at least one processor is further configured to execute the instructions to:
display a user interface including the plurality of devices in the group list, and
based on receiving a user input selecting one or more devices in the group list, cause the selected one or more devices to perform the operation corresponding to the voice instruction instead of the device.

19. The device according to claim 15, wherein the plurality of devices in the group list are registered to an account of the user.

20. The device according to claim 15, wherein the group list includes a device registered to an account of another user.
